(19) United States
(12) Patent Application Publication
(10) Pub. No.: US 2014/0312132 A1
(43) Pub. Date: Oct. 23, 2014

(54) POST-INJECTION STRATEGY OPTIMIZATION FOR CABIN COMFORT IN DIESEL-POWERED VEHICLES

(71) Applicant: FORD GLOBAL TECHNOLOGIES, LLC, Dearborn, MI (US)

(72) Inventors: RANGANATHAN MADHAVAN, CANTON, MI (US); MANFRED KOBERSTEIN, TROY, MI (US); MARKUS MARKOWITZ, KOELN (DE)

(73) Assignee: FORD GLOBAL TECHNOLOGIES, LLC, Dearborn, MI (US)

(21) Appl. No.: 13/868,128

(22) Filed: Apr. 23, 2013

(51) Int. Cl. B60H 1/03

(52) U.S. Cl. CPC B60H 1/036
USPC 237/12.3 R; 165/41

(57) ABSTRACT

A method of optimizing usage of post-injection strategy for improved cabin comfort in a vehicle includes detecting a set of conditions corresponding to parameters pertaining to the vehicle's hardware components, driving components and operating conditions. If one or more of the set of conditions are satisfied, the method implements the post-injection strategy for the vehicle, for a pre-determined time, if the fuel-oil ratio for the engine of the vehicle is lower than a pre-determined value.

### TECHNICAL FIELD

Embodiments of the present disclosure generally relate to diesel-powered automotive vehicles, and, more specifically, to use of post-injection technology in such vehicles, to extract more heat from the engine coolant for cabin comfort during cold weather conditions.

### BACKGROUND

In general, diesel engines tend to produce less heat than do gasoline engines. Therefore, providing sufficient cabin comfort during the winter can be a major problem in vehicles equipped with diesel engines. Typically, vehicle cabin heating is accomplished by capturing waste heat, typically from the vehicle's coolant system, and using that heat to raise the temperature of an airstream being fed into the vehicle cabin. If the coolant temperature remains relatively low, insufficient heat will be present to raise the temperature of the airstream.

Many diesel-powered vehicles employ Positive Temperature Coefficient (PTC) heaters or fuel-operated h and eaters, to provide cabin comfort. PTC heaters incorporate heating elements consisting of ceramic surfaces, which have self-limiting temperature characteristics. Above a pre-defined reference temperature, PTC heaters exhibit very fast heating response times. Specifically, the ferromagnetic and electrical properties of ceramic allow a quick rise in temperature of PTC heaters and subsequently of the cabin air which is directed through the PTC heaters.

Through the use of new innovative technologies, attempts have been continuously made to improve cabin comfort in diesel-powered vehicles. One such technology attempts to capture the heat generated during post-injection regeneration, a process for incinerating accumulated site in diesel particulate filters. That process has not been completely successful, however, and in particular that process has been observed to increase fuel-oil dilution problems in such systems.

Considering the problems mentioned above, and other shortcomings in the art, there remains a need for a method for optimizing the use of post-injection regeneration in diesel engines, while minimizing the oil dilution problems.

### SUMMARY

The present disclosure provides a method of optimally implementing fuel post-injection strategy for a vehicle equipped with diesel engine, to produce more heat to the coolant of the engine of the vehicle, while minimizing the problems of engine oil dilution occurring due to post-injection.

One aspect of the disclosure presents a method for employing post-injection regeneration, to improve cabin comfort in a diesel-powered vehicle. That method begins by determining whether vehicle components are capable of providing sufficient heat to provide cabin comfort and continues by determining whether a cabin heating system is receiving sufficient heat to provide cabin comfort. Upon determining that the local components are capable of providing sufficient heat to provide cabin comfort and that the cabin heating system is not receiving sufficient heat to provide cabin comfort, the system initiates post-injection regeneration, and during that process, upon determining that cumulative post-injection regeneration time exceeds a predetermined limit, or that a fuel-oil ratio exceeds a predetermined limit, the system terminates and disables post-injection regeneration.

Additional aspects, features, advantages and objects of the present disclosure would be made apparent from the drawings and the detailed description of the illustrative embodiments, construed in conjunction with the appended claims that follow.

### BRIEF DESCRIPTION OF THE DRAWINGS

FIG. 1 is a flow chart illustrating the steps involved in a method for optimizing the usage of post-injection strategy in a vehicle, for improving the cabin comfort, while and minimizing the fuel-oil dilution problems, in accordance with the present disclosure.

### DETAILED DESCRIPTION OF ILLUSTRATIVE EMBODIMENTS

The following detailed description illustrates aspects of the claimed invention and the ways to implement it. However, the description is not intended to define or limit the invention, such definition or limitation being solely contained in the claims appended thereto. Although the best mode of carrying out the invention has been disclosed comprehensively, those in the art will recognize that other embodiments for carrying out or practicing the invention are also possible.

Diesel particulate filters are devices designed to remove diesel particulate matter, primarily soot, from the exhaust gas of diesel engines. After some time, however, the soot accumulates in the filter, and if not removed, the soot can complete the plugged the filter. The technique of removing the soot from the filter is known as ‘filter regeneration’.

A technique referred to as post-injection regeneration is now widely used in diesel engines for filter regeneration. The strategy initiates by vaporizing the diesel fuel, without burning it. The vaporized fuel is then directed through the exhaust valves of the engine to the particulate filter, where the fuel is introduced to a catalyst. The catalyst and the unburned fuel react in an exothermic reaction that incinerates the accumulated particulate matter. Alternatively, unburnt fuel may be injected directly into the exhaust gas stream by a vaporizer; this technique requires lower levels of post-injection.

During post-injection, fuel is diverted from the combustion process, which of course reduces the efficiency of the engine. Reduced efficiency in turn leads to added engine operation per unit of distance traveled, which results in added engine operation, producing more heat. Thus, post-injection can be harnessed to provide additional heat for cabin warming.

During the post-injection process, the heavier fractions of the fuel are left unvaporized, and these fractions find their way out between the piston rings and cylinder walls. Eventually, such particles accumulate in the crankcase of the engine, where they dilute the engine oil. This is a major issue accompanying the post-injection strategy in diesel engine. Therefore, a post-injection strategy for improving cabin comfort may generally create problems such as engine-oil dilution. It should be noted that where lower levels of post-injection are employed, such as when post-injection is provided earlier in the filter cycle, then dilution problems are reduced. The present disclosure therefore offers an additional benefit of reducing overall fuel dilution.

The present disclosure is directed to a strategic use of post-injection technology in vehicles incorporating diesel engines, to extract more heat from the engine coolant for cabin comfort, during cold weather conditions. The method simultaneously minimizes the fuel-oil dilution problems. It should be noted that the present disclosure does not deal with the issue of capturing the heat produced during the regeneration process and effectively using that heat to improve cabin comfort. Those in the art will be able to employ any of the suitable conventional devices, many related to intercooler technology, and transferring that heat to the airstream employed to maintain an even cabin temperature.

Specifically, the method of the present disclosure monitors certain conditions corresponding to a set of parameters pertaining to the vehicle's hardware conditions, driving conditions, and operating conditions for the different components of the vehicle. The post-injection technique is implemented if those conditions are satisfied, and further, only if the fuel-oil ratio for the engine of the vehicle is lower than a certain pre-determined threshold value. The enabled technology is disabled when the fuel-oil ratio goes above that threshold value.

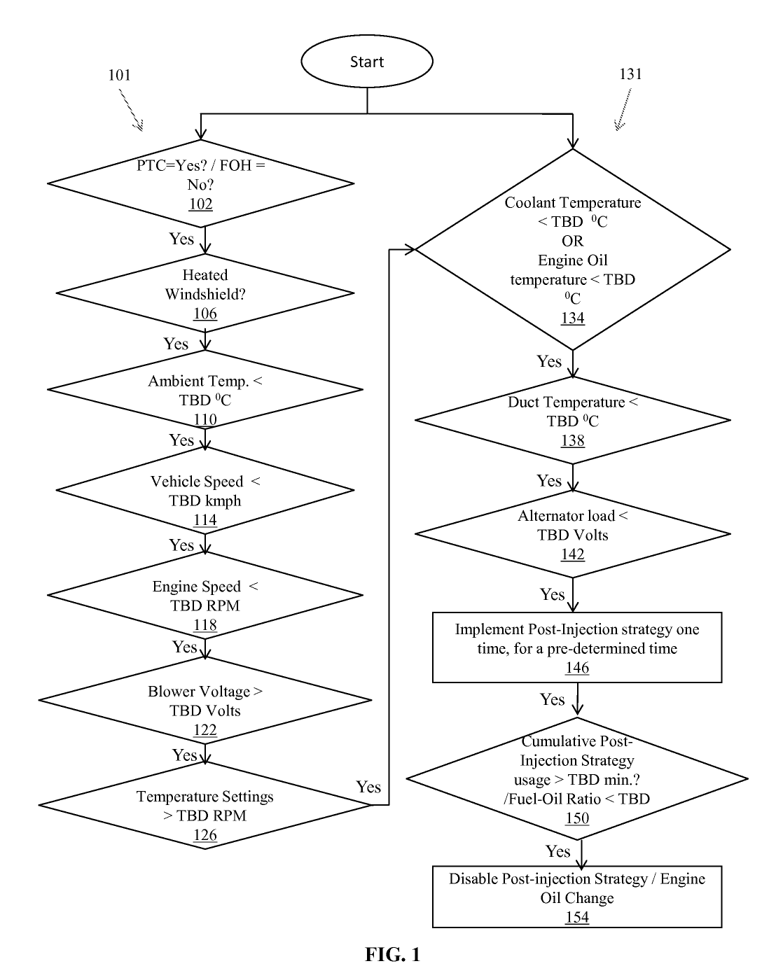

FIG. 1 is a flow chart illustrating the steps involved in a method for strategically using the post-injection technology in a vehicle incorporating a diesel engine. The method provides improved cabin comfort, by using more heat from the coolant of the engine of the vehicle during the process of implementing the strategy. Further, the method substantially avoids the problem of engine fuel-oil dilution, which normally occurs while implementing post-injection techniques.

As shown in the flowchart, the disclosed process evaluates two sets of parameters. A first set, termed operating parameters 101, relates to operating and ambient conditions. Generally, these parameters address the question whether vehicle components are capable of generating sufficient heat to provide for cabin comfort. For example, if engine RPM is not above a certain threshold, then one can infer that the engine will produce insufficient heat for transfer to the engine coolant to provide significant cabin heating. A second set of parameters, termed heating system parameters 130, focuses on whether the vehicle cabin heating system is actually receiving sufficient heat to provide adequate cabin comfort. These parameters directly measure conditions within the heating system, such as the coolant temperature and the heating airstream temperature. The system applies a determined logical function to each set of parameters, and the results of that analysis are then evaluated by a further logical function.

Operating parameters 101 are evaluated in steps 102-126. Each parameter is stated as a condition, which the system evaluates logically.

Starting at step 102, the method evaluates the type of cabin heater present in the vehicle, based on two conditions—first, whether the vehicle is equipped with a Positive Temperature Coefficient (PTC) heater, and second whether the vehicle does not employ a fuel operated heater. If both of those conditions are met, than those functions are related as a logical TRUE.

Next, then at step 106, the method checks whether the windshield heater function is currently activated. If that function is not activated, step 106 scores as a logical TRUE. Then, at step 110, the method determines whether the ambient temperature is below a preselected threshold. Ambient temperature may be detected by one or more conventional outside temperature sensors and stored at a convenient memory location in the vehicle's control system. If the ambient temperature is below the threshold value, then step 110 is scored as logically TRUE. In one embodiment, the calibrated threshold value may lie within the range of 12-15° C. Other ranges may be selected based on expected conditions in the operating area of the vehicle, and indeed, temperature ranges may be set to vary by season.

Step 114 evaluates the condition that the current vehicle speed, in KPH, is below a preselected value. If vehicle speed exceeds the stated threshold, the engine most likely is generating sufficient heat to warm the cabin without the additional boost to be provided by post-injection regeneration. A typical evaluation value for this parameter could be about 60-100 km/h.

Next, the system determines whether the engine speed exceeds and establishes a threshold value (step 118). While the vehicle speed is a good first measure of the heat being generated by the engine, the vehicle speed could be produced by running in a high gear, which would produce a relatively low engine rpm, generating insufficient heat to warm the cabin. Directly measuring the rpm, by sampling the output of the tachometer, for example, directly determines how hard the engine is working. Typical threshold rpm values depend upon the specific engine in question but could be about 1500-3000 rpm.

Eventually, at step 122, the system evaluates whether the HVAC blower motor voltage exceeds pre-determined value. The blower is an integral part of the cabin temperature control systems of the vehicle, and if its voltage lies below the pre-determined value, then the heating system is not being operated, and therefore a further boost to that system is not required.

Finally, at step 126, the method determines whether the temperature settings of the air-conditioning system incorporated within the vehicle, and checks whether the heater temperature control is set at/close to the maximum temperature value settings, such as FULL HOT.

The set of parameters is subjected to a logical AND operation, which returns a value of TRUE if every condition is met. Once the conditions specified at steps 102-126 are satisfied, the method continues to a series of steps 134-142, where heating system parameters 130 are evaluated.

Specifically, proceeding from step 126, at steps 134 and 134, the method detects the temperature of both the coolant, and the engine oil to determine whether either value is below a preselected threshold (a logical OR operation). Either the coolant of the oil could be a source of waste heat, useful for heating the vehicle cabin, and if sufficient heat is available from either source, post-injection regeneration will not be required. Temperature sensors are generally disposed to provide temperatures for the engine oil and the engine coolant, and those signals are easily accessed.

If both the engine oil and the engine coolant are found to lie below their respective threshold values, then the method proceeds to step 138, where the temperature of the air blowing out of the heater duct is measured, and compared with a preselected value. Rather than relying on an indirect measurement, such as inferring the adequacy of cabin heating from the coolant temperature, this measurement directly assesses the critical value. Clearly, if the heater duct is providing air at a sufficiently warm temperature, post-injection regeneration is not required for additional heat. Typical minimum temperature values here could be about 40-50° C. Proceeding to step 142, the method determines whether the electrical load (current) generated by the alternator for the engine of the vehicle falls below a pre-determined value. As would be clear to those in the art, low alternator output may correspond to low engine rpm, which in turn would indicate inadequate heat being generated to maintain cabin comfort. A threshold level for this measurement could be about 50 A.

Operating parameters 101 and heating system parameters 130 are each subjected to logical AND operations and the results of those operations are in turn evaluated with a logical AND operation. Returning a TRUE value from that operation results in the initiation of post-injection regeneration at step 146, for a pre-determined time. The pre-determined time for one-time implementation of the post-injection strategy may be about 20-30 minutes. However, the time for implementation may vary in different embodiments, based on factors such as the size and capacity of the engine, the time duration for which the vehicle has been in running conditions, and the time for which the engine of the vehicle has been turned-on, or has been under engine idling condition, etc.

Each time the set of conditions of steps 102-142 are cumulatively satisfied, post-injection regeneration is implemented.

There, the method uses a timer to keep track of the cumulative time for which the post-injection regeneration has been operated. This time value may be stored in a database coupled to the engine control module of the vehicle. Further, the method also continuously measures the fuel-oil ratio, employing any of the conventional methods for doing so. At step 154, on detecting that the cumulative time of usage of the post-injection strategy has crossed the threshold time value, or that the fuel-oil ratio exceeds its limit, the activated post-injection strategy is disabled, and any further usage of the post-injection is stopped by the method, until the engine oil is changed. This step avoids engine oil dilution problems which generally have been an issue in conventional implementations of post-injection regeneration.

The series of steps 102-146, for detecting the conditions pertaining to different parameters corresponding to the vehicle's operating and driving conditions, may be either conducted as purely logical operations, employing logic hardware well known in the art, or the parameters may be sequentially tested and evaluated. In the latter example, discontinuing the test series after a condition is evaluated negatively may simulate the operation of the AND logical function. Also, it is contemplated that the order of conditions or queries may also vary in certain embodiments. Further, the first set of conditions pertaining to the vehicle's hardware and driving conditions, i.e., the conditions belonging to the 102-126, and the second set of conditions pertaining to the operating state/properties of the different components of the vehicle, i.e., those belonging to the steps 134-142, may also be carried out simultaneously, before a decision is made by the engine control module of the vehicle, for carrying out the post-injection technique. Also, in certain embodiments, one or more conditions among those depicted in the flowchart, may also be skipped, considering them being indirectly incorporated by an equivalent conditional check within the method. For example, in certain embodiments, either of the engine oil or the engine coolant temperature is detected and compared with a corresponding threshold value, before proceeding to the next conditional step of the method. Specifically, the conditions specified at the different steps of the illustrated flowchart, for implementing the method of the present disclosure, are contributory indicators towards optimally using the post- injection strategy for the vehicle, to extract more heat from the engine coolant for improved cabin comfort, while simultaneously avoiding the fuel-oil dilution problems that normally accompany during the process of implementation of the post-injection strategy in diesel engines.

The method of the disclosure, for optimizing usage of post-injection strategy, for improved cabin comfort, can be implemented in any vehicles incorporating a diesel engine, including cars, SUVs, pick-up trucks, etc.

Although the current invention has been described comprehensively, in considerable details to cover the possible aspects and embodiments, those skilled in the art would recognize that other versions of the invention may also be possible. Though, different embodiments of the present disclosure have been set forth above, and different constructions of the invention have been depicted in the appended drawings, however, the disclosed embodiments are not intended to define or limit the scope of the disclosure, such limitation being solely contained in the claims appended hereto, and therefore, other embodiments for carrying out the invention are also possible.

What is claimed is:

1. A method for employing post-injection regeneration, to improve cabin comfort in a diesel-powered vehicle, the method comprising:
determining whether vehicle components are capable of providing sufficient heat to provide cabin comfort;
determining whether a cabin heating system is receiving sufficient heat to provide cabin comfort;
upon determining that the local components are capable of providing sufficient heat to provide cabin comfort and that the cabin heating system is not receiving sufficient heat to provide cabin comfort, initiating post-injection regeneration; and
during post-injection regeneration, upon determining that cumulative post-injection regeneration time exceeds a predetermined limit, or that a fuel-oil ratio exceeds a predetermined limit, terminating and disabling post-injection regeneration.

2. The method of claim 1, wherein determining whether vehicle components are capable of providing sufficient heat to provide cabin comfort includes evaluating one or more conditions, each condition relating to a selected operational characteristic.

3. The method of claim 2, wherein the one or more conditions include:
the vehicle heater type is Positive Temperature Coefficient and not Fuel Operated;
the windshield heater is not activated;
the ambient temperature is less than a pre-determined threshold;
the vehicle speed is less than a pre-determined kph threshold;
the engine speed is less than a pre-determined RPM threshold;
the HVAC blower voltage is greater than a pre-determined value; and
the cabin heater temperature setting is at a maximum temperature value.

4. The method of claim 1, wherein determining whether vehicle components are providing sufficient heat to provide cabin comfort includes evaluating one or more conditions, each condition relating to a selected operational characteristic of the cabin heating system.

5. The method of claim 4, wherein the one or more conditions include one or more of:
the engine coolant temperature is less than a pre-determined value;
the engine oil temperature is less than a pre-determined value; or
the alternator load is less than a predetermined current value.

6. The method of claim 1, further comprising, tracking a cumulative time during which post-injection regeneration has been active, to obtain a cumulative post-injection regeneration time.

7. The method of claim 6, further comprising, resetting the cumulative time to a zero value each time the engine oil is changed.

8. A method for employing post-injection regeneration, to improve cabin comfort in a diesel-powered vehicle, the method comprising:
determining whether vehicle components are capable of providing sufficient heat to provide cabin comfort by evaluating one or more conditions, each condition relating to a selected operational characteristic, the conditions including:
the vehicle heater type is Positive Temperature Coefficient and not Fuel Operated;
the ambient temperature is less than a pre-determined threshold;
the vehicle speed is less than a pre-determined kph threshold;
the engine speed is less than a pre-determined RPM threshold;
the HVAC blower voltage is greater than a pre-determined value; and
the cabin heater temperature setting is at a maximum temperature value;
determining whether a cabin heating system is receiving sufficient heat to provide the cabin comfort each condition relating to a selected operational characteristic, the conditions including:
the engine coolant temperature is less than a pre-determined value;
the windshield heater is not activated;
the engine oil temperature is less than a pre-determined value; and
the alternator load is less than a predetermined current value;
upon determining that the local components are capable of providing sufficient heat to provide cabin comfort and fact the cabin heating system is not receiving sufficient heat to provide cabin comfort, initiating post-injection regeneration;
during post-injection regeneration, upon determining that cumulative post-injection regeneration time exceeds a predetermined limit, or that a fuel-oil ratio exceeds a predetermined limit, terminating and disabling post-injection regeneration.

9. A method for employing post-injection regeneration, to improve cabin comfort in a diesel-powered vehicle, the method comprising:
determining whether vehicle components are capable of providing sufficient heat to provide cabin comfort by evaluating one or more conditions, each condition relating to a selected operational characteristic, the conditions including:
the vehicle heater type is Positive Temperature Coefficient and not Fuel Operated;
the ambient temperature is less than about 12-15° C.;
the vehicle speed is less than about 60-100 km/h;
the engine speed is less than about 1500-3000 rpm;
the HVAC blower voltage is greater than a predetermined value; and
the cabin heater temperature setting is at a maximum temperature value;
determining whether a cabin heating system is receiving sufficient heat to provide the cabin comfort each condition relating to a selected operational characteristic, the conditions including:
the engine coolant temperature is less than a pre-determined value;
the windshield heater is not activated;
the engine oil temperature is less than a pre-determined value; and
the alternator load is less than a predetermined current value;
upon determining that the local components are capable of providing sufficient heat to provide cabin comfort and fact the cabin heating system is not receiving sufficient heat to provide cabin comfort, initiating post-injection regeneration;
during post-injection regeneration, upon determining that cumulative post-injection regeneration time exceeds a predetermined limit, or that a fuel-oil ratio exceeds a predetermined limit, terminating and disabling post-injection regeneration.
